(19) United States
(12) Patent Application Publication
(10) Pub. No.: US 2020/0033473 A1
(43) Pub. Date: Jan. 30, 2020

(54) METHOD FOR OPERATING AN ULTRASONIC SENSOR, WHICH IS INSTALLED IN A CONCEALED MANNER, OF A VEHICLE

(71) Applicant: Robert Bosch GmbH, Stuttgart (DE)

(72) Inventors: David Weidenfelder, Leonberg (DE); Michael Schumann, Stuttgart (DE)

(21) Appl. No.: 16/483,611

(22) PCT Filed: Jan. 11, 2018
(86) PCT No.: PCT/EP2018/050634

§ 371 Date: Aug. 5, 2019

(30) Foreign Application Priority Data
Feb. 8, 2017 (DE) 10 2017 201 978.6

(51) Int. Cl. G01S 15/93; G01S 7/527; G01S 7/52

(52) U.S. Cl. CPC G01S 15/931; G01S 7/521; G01S 7/52006; G01S 7/527

(57) ABSTRACT

A method is provided for operating an ultrasonic sensor installed in a concealed manner such that a diaphragm of the sensor is connected to a vehicle part whose instantaneous properties influence a directional characteristic of the sensor, where a threshold value is used to suppress interference signals in the case of pulse-echo measurements using the ultrasonic sensor. The method adapts the threshold value to the directional characteristic of the ultrasonic sensor predetermined according to the instantaneous properties of the vehicle part. Further aspects of the invention relate to a driver assistance system including at least one ultrasonic sensor installed in a concealed manner and a computer program product which is designed to execute the method.

### CROSS-REFERENCE TO RELATED APPLICATIONS

The present application is the national stage of International Pat. App. No. PCT/EP2018/050634 filed Jan. 11, 2018, and claims priority under 35 U.S.C. § 119 to DE 10 2017 201 978.6, filed in the Federal Republic of Germany on Feb. 8, 2017, the content of each of which are incorporated herein by reference in their entireties.

### FIELD OF THE INVENTION

The present invention relates to a method for operating an ultrasonic sensor of a vehicle, the ultrasonic sensor being installed in a concealed manner, in such a way that a diaphragm of the ultrasonic sensor is connected to a vehicle part, the instantaneous properties of the vehicle part influencing a directional characteristic of the ultrasonic sensor. Further aspects of the present invention include a driver assistance system, which includes at least one ultrasonic sensor installed in a concealed manner, and a computer program product, which is designed to execute the method.

### BACKGROUND

Modern vehicles are equipped with a plurality of driver assistance systems, which assist the driver when carrying out various driving maneuvers using data about the surroundings of the vehicle. Such driver assistance systems require the most accurate possible image of the surroundings of the vehicle to fulfill their tasks. The image of the surroundings of the vehicle is produced using various sensors, for example, using ultrasonic sensors. A signal is emitted by the ultrasonic sensors, the echo of which as it reflects off an obstacle being registered in turn by the ultrasonic sensors, i.e., the same or a different one than the emitting sensor, at the vehicle. The distance between the vehicle and the reflecting obstacle can be computed from the time which has passed between emitting and receiving the signal and the known propagation speed of the signal. Such ultrasonic sensors have a field of view, within which these obstacles can be perceived. The sensitivity of the ultrasonic sensors decreases toward the periphery of their field of view. To suppress interfering signals, which arise, for example, due to irregularities of the underlying surface, so that the ground partially reflects the emitted signal, a threshold value is provided. An obstacle is only concluded if the signal strength of the received echo signal is greater than the threshold value.

It is preferable for aesthetic reasons to situate the ultrasonic sensors in a concealed manner on the vehicle. For this purpose, for example, they are installed behind a bumper or another vehicle part, in such a way that they are not visible. It is to be noted in this case that the properties of the vehicle part influence the properties of the ultrasonic sensor, in particular also its field of view.

A method and a device for setting the sensitivity of an ultrasonic sensor are known from document DE 10 2015 211 467 B3. To suppress interference, an interference threshold value is provided, which is ascertained during the operation of the ultrasonic sensor. To avoid the threshold value being set in such a non-sensitive way due to strong interference that a field of view is significantly changed, a maximum threshold value is provided. If the ascertained interference threshold value is greater than the maximum threshold value, the maximum threshold value is thus used. If the ascertained interference threshold value is less than the maximum threshold value, the ascertained interference threshold value is thus used. The maximum threshold value is determined in such a way that a reference object can be ascertained throughout the detection area.

An ultrasonic sensor having a settable acquisition area is known from DE 10 2004 037 723 A1. The acquisition area is produced by a change of a switching point curve of the ultrasonic sensor by way of influencing the threshold value curves. In addition, it is possible to set the threshold values automatically as a function of ambient conditions such as the temperature.

In the case of an ultrasonic sensor installed in a concealed manner, a diaphragm of an ultrasound generator is connected to a vehicle part in such a way that a vehicle part and the diaphragm jointly form an oscillating system, which emits the ultrasonic signals and in turn receives reflected echoes. The properties of this oscillating system are accordingly predetermined not only by the ultrasonic sensor or its diaphragm, but are also dependent on the material properties of the vehicle part. It is therefore desirable to also take into consideration the instantaneous material properties of this vehicle part during the operation of an ultrasonic sensor.

### SUMMARY

An example embodiment of the present invention is directed to a method for operating an ultrasonic sensor of a vehicle, the ultrasonic sensor being installed in a concealed manner, in such a way that a diaphragm of the ultrasonic sensor is connected to a vehicle part, the instantaneous properties of the vehicle part influencing a directional characteristic of the ultrasonic sensor. During the operation of the ultrasonic sensor, pulse-echo measurements are executed using the ultrasonic sensor, a threshold value being used to suppress interference signals in the pulse-echo measurement. The threshold value is adapted to the directional characteristic of the ultrasonic sensor predetermined by the instantaneous properties of the vehicle part.

In a first variant a), the adaptation of the threshold value to the instantaneous directional characteristic is carried out by ascertaining a temperature and determining the threshold value using a previously ascertained relationship between the temperature and the directional characteristic.

In a second variant b), the adaptation of the threshold value to the instantaneous directional characteristic is carried out by determining a resonant frequency of an oscillating system formed from the diaphragm and the vehicle part and determining the threshold value using a previously ascertained relationship between the resonant frequency and the directional characteristic.

For a concealed installation of the ultrasonic sensor, it is preferably situated on an inner side of an outer wall of a vehicle part. The diaphragm of the ultrasonic sensor is typically connected to the outer wall of this vehicle part. The vehicle part can be, for example, a bumper. The connection can be produced, for example, by adhesive bonding.

During the operation of the ultrasonic sensor, pulse-echo measurements are executed, ultrasonic signals being emitted using the ultrasonic sensor and echoes from objects in the surroundings being received in turn. A threshold value is set to differentiate between an echo of an object and an interference signal. If a signal strength of a received echo signal is greater than the threshold value, the received echo signal is thus interpreted as an echo of an object in the surroundings. If the signal amplitude is less than the threshold value, the received echo signal is thus classified as an interference signal and suppressed.

The ultrasonic sensors used have a field of view, within which they can detect objects. The sensitivity of the ultrasonic sensor decreases toward the periphery of the field of view. The field of view is dependent on the directional characteristic of the ultrasonic sensor. The directional characteristic describes the direction dependency of the sound emission and can be characterized via a vertical or horizontal aperture angle. The aperture angle is typically defined by a drop of the amplitude of the emitted ultrasonic signal to a predetermined value. This amplitude is in turn dependent on the frequency of the ultrasonic signal used, properties of the sound transducer, the material properties of the vehicle part to which the diaphragm of the ultrasonic sensor is connected, and the properties of the connection between the diaphragm and the vehicle part. These material properties can change as a function of the instantaneous ambient conditions, in particular as a function of the instantaneous temperature. In particular in the case of plastics, which are typically used as a material for vehicle parts such as bumpers, a change of material parameters takes place with the temperature. For example, the properties of a connection between the ultrasonic sensor and the vehicle part, for example, the material properties of an adhesive bond, can also change with the temperature. These changes of the material parameters effectuate in particular a shift of the resonant frequency of the oscillating system formed from the vehicle part and diaphragm. In this case, the material possibly used for the connection between the ultrasonic sensor and the vehicle part, for example, an adhesive bond, is also part of the oscillating system. The aperture angle, which is a measure of the directional characteristic, is dependent in particular on the resonant frequency of the oscillating system, since the aperture angle is dependent on the quotient of the wavelength and the diaphragm diameter. In the event of a temperature change, the diaphragm diameter remains approximately constant, so that in the event of a temperature change, the directional characteristic is essentially determined by a change of the resonant frequency. With decreasing temperature, the resonant frequency shifts toward higher frequencies, which results in a reduction of the horizontal and vertical aperture angle. With increase of the temperature, the resonant frequency decreases and the horizontal and vertical aperture angle increase.

In the event of an increase of the aperture angle, in particular the vertical aperture angle, the directional characteristic of the ultrasonic sensor changes in such a way that the emitted ultrasonic signal of an ultrasonic sensor situated on the vehicle is incident on the ground earlier, i.e., at a shorter distance from the vehicle, and having a greater intensity. It is thus to be expected that the intensity of interference signals caused by reflections on the ground will also increase. It was therefore typical in the related art, in conjunction with ultrasonic sensors installed in a concealed manner, to select the threshold value to suppress interference signals in such a way that interference signals are also reliably suppressed at the highest expected temperature. However, this has the result that at low temperatures, which result in a reduction of the horizontal and vertical aperture angle and thus in a reduction of the directional characteristic, the field of view of the ultrasonic sensor is smaller at low ambient temperatures than at high ambient temperatures. It is therefore preferable according to the presented variant of the method to reduce the threshold value if, as a result of a change of the environmental conditions, the directional characteristic is changed in such a way that the horizontal and/or the vertical aperture angle is reduced and, vice versa, to raise the threshold value if, due to a change of the environmental conditions, the directional characteristic is changed in such a way that the vertical and/or the horizontal aperture angle of the ultrasonic sensor is increased.

The temperature of variant a) is preferably an external temperature ascertained via a thermometer of the vehicle. It is advantageous in this case that vehicles generally have a thermometer to determine the external temperature, in such a way that no further sensor has to be situated. Alternatively, an additional temperature sensor can be situated on the vehicle part or integrated into the ultrasonic sensor, in such a way that the temperature of variant a) is a temperature of the vehicle part ascertained via this temperature sensor. In this alternative, it is necessary to arrange a further sensor, however, the direct determination of the temperature of the vehicle part is more precise than a measurement of the external temperature.

The relationship between the temperature and the directional characteristic and/or the relationship between the resonant frequency and the directional characteristic are preferably determined beforehand by measurements. For this purpose, for example, the ultrasonic sensor installed in a concealed manner on the vehicle part can be situated in a climate chamber, the aperture angles defining the directional characteristic, in particular the horizontal and the vertical aperture angle, being determined for various temperatures. In the case of the ascertainment of a relationship between temperature and the directional characteristic, it is not necessary to determine the resonant frequency of the ultrasonic sensor for every one of the set temperatures. For a determination of the relationship between the resonant frequency and the directional characteristic, the resonant frequency of the oscillating system is varied, for example, by setting various temperatures, and the aperture angles defining the directional characteristic, in particular a horizontal and a vertical aperture angle, are determined for various resonant frequencies which are set, for example, by changing the temperature.

In an example embodiment of the method, a value table is determined on the basis of the measurements carried out, which table contains the ascertained horizontal and/or vertical aperture angles for a predetermined temperature or a resonant frequency. Alternatively or additionally, it is possible to determine a value table which contains an optimum predetermined threshold value for a temperature or a resonant frequency. In the latter case, complex computations for determining the optimum threshold value can be omitted during the operation of the ultrasonic sensor, and the particular optimum threshold value can be read out from the value table directly on the basis of the determined temperature and/or the determined resonant frequency.

The previously determined value table is preferably stored in a memory of a control unit, in such a way that it is available during the operation of the ultrasonic sensor.

Alternatively or additionally, an approximation formula can be determined, for example, using a curve adaptation method, which describes the dependence of the directional characteristic or the horizontal and/or vertical aperture angle defining it on the temperature and/or on the resonant frequency. Alternatively or additionally, for example, an approximation formula can be determined via a curve adaptation method, using which the optimum threshold value can be determined in dependence on a temperature or a resonant frequency. These previously determined approximation formulas can be stored, for example, in a memory of a control unit, in such a way that they are available during the execution of the method.

A measurement of the impedance of the ultrasonic sensor is preferably executed for the determination of the resonant frequency according to variant b) of the method. To carry out the impedance measurement, the sound transducer of the ultrasonic sensor is preferably excited using electric signals of various frequencies, the electric resistance being measured in each case. In the range of the resonant frequency, the electric resistance of the sound transducer decreases in such a way that the resonant frequency can be concluded.

As a further variant c), a method for operating an ultrasonic sensor of a vehicle is presented, the ultrasonic sensor being installed in a concealed manner, in such a way that a diaphragm of the ultrasonic sensor is connected to a vehicle part, the instantaneous properties of the vehicle part influencing a directional characteristic of the ultrasonic sensor. During the operation of the ultrasonic sensor, pulse-echo measurements are executed using the ultrasonic sensor, a threshold value being used to suppress interference signals in the pulse-echo measurements. It is provided that an adaptation of the threshold value of the ultrasonic sensor is carried out by regulating the threshold value using interference signals received during the pulse-echo measurements.

The threshold value is preferably regulated according to the regulation of variant c) of the method in such a way that a constant predetermined false alarm rate is maintained. A false alarm is an interference signal which has an amplitude greater than the threshold value and is thus incorrectly considered to be an echo signal of an object. If the false alarm rate increases, the threshold value is thus raised and, vice versa, the threshold value is lowered if the false alarm rate decreases. In this embodiment variant, the entire signal chain is advantageously taken into consideration for the regulation of the threshold value, in such a way that in addition to a directional characteristic changed because of changed environmental conditions, further factors are also taken into consideration, for example, aging of the material.

The interference signals to be suppressed include in particular signals caused by ground reflections, which interference signals increase with a broadening of the directional characteristic by which in particular the horizontal and/or the vertical aperture angle is increased, and which decrease with a narrowing of the directional characteristic upon which in particular the horizontal and/or the vertical aperture angle decreases.

According to an example embodiment of the present invention, a computer program is furthermore presented, according to which a method described herein is carried out when the computer program is executed on a programmable computer unit. The computer program can be, for example, a module for implementing a driver assistance system or a subsystem thereof in a vehicle. The computer program can be stored on a machine-readable storage medium, for example, on a permanent or rewritable storage medium, or in association with a computer unit or on a removable CD-ROM, DVD, Blu-ray disc, or a USB stick. Additionally or alternatively, the computer program can be provided on a computer unit, for example, on a server for downloading, for example, in the case of a data network such as the Internet or a communication connection such as a telephone line or a wireless connection.

Furthermore, a driver assistance system for assisting a driver of a vehicle is presented according to the present invention. The driver assistance system includes at least one ultrasonic sensor installed in a concealed manner and a control unit, a diaphragm of the ultrasonic sensor forming an oscillating system with a vehicle part. The control unit is designed to execute one of the methods described herein. The features described in the scope of one of the methods therefore apply accordingly to the driver assistance system and, conversely, features described in the scope of the driver assistance system apply accordingly to the methods.

The driver assistance system can be designed, for example, as a parking assistant, using which parking spaces in the surroundings of the vehicle are ascertained and the vehicle is possibly guided into one of the ascertained parking spaces. Further design options are, for example, a blind spot assistant that warns the driver of the vehicle about objects in the blind spot, or a back-up assistant, which assists the driver during backward travel of the vehicle.

The driver assistance system preferably additionally includes a temperature sensor for determining the temperature of the vehicle part, to which the at least one ultrasonic sensor is connected. Alternatively or additionally, it can be provided that the driver assistance system is connected to an external thermometer of the vehicle to ascertain an external temperature of the vehicle. The temperature ascertained using the external monitor or the sensor is preferably used in conjunction with the execution of variant a) of the method.

A threshold value used in pulse-echo measurements for suppressing interference signals is adapted to the instantaneous directional characteristic of the ultrasonic sensor by the presented method for operating an ultrasonic sensor installed in a concealed manner. The directional characteristic is strongly dependent in ultrasonic sensors installed in a concealed manner on the environmental conditions, since the directional characteristic is also dependent on the properties of the vehicle part, in addition to the properties of the ultrasonic sensor. With increasing temperature, the directional characteristic changes in such a way that a horizontal and a vertical aperture angle, at which signals are emitted by the ultrasonic sensor, are increased. The emitted ultrasonic signal is thus already incident on the ground after a shorter distance from the vehicle and at higher intensity, in such a way that ground echoes reflected from the ground are also received at higher signal strength by the ultrasonic sensor. Without the presented consideration of this temperature dependence of the directional characteristic, the threshold value would have to be selected in such a way that ground echoes are reliably suppressed even at the greatest expected temperature of the vehicle part. However, this has a disadvantage that, conversely, lower temperatures are associated with a smaller field of view. The low temperatures result in a small horizontal and/or vertical aperture angle, at which signals are emitted from the ultrasonic sensor, whereby a smaller field of view is associated in conjunction with the high threshold value. By way of the presented adaptive setting of the threshold value, it can be reduced at low temperatures, in such a way that reflections of objects having lower signal strengths are also registered. The field of view of the sensor, i.e., the area in which it can recognize the objects in the surroundings of the vehicle, is advantageously expanded in this way. The field of view of the sensor is no longer dependent on the ambient temperature due to the selection of the threshold value adapted to the directional characteristic, in such a way that in particular objects at the edge of the field of view of the ultrasonic sensor can be reliably recognized independently of the instantaneous ambient temperature and thus independently of the instantaneous directional characteristic of the sensor.

Example embodiments of the present invention are shown in the drawings and explained in greater detail in the following description.

### BRIEF DESCRIPTION OF THE DRAWINGS

FIG. 1 shows a vehicle including an ultrasonic sensor installed in a concealed manner, according to an example embodiment of the present invention.

FIG. 2a shows a simulation of the horizontal aperture angle according to an example embodiment of the sensor of the present invention.

FIG. 2b shows a simulation of the vertical aperture angle, according to an example embodiment of the sensor of the present invention.

FIG. 3 shows a diagram of the amplitude of a ground echo signal in relation to the distance from the ultrasonic sensor, according to an example embodiment of the sensor of the present invention.

### DETAILED DESCRIPTION

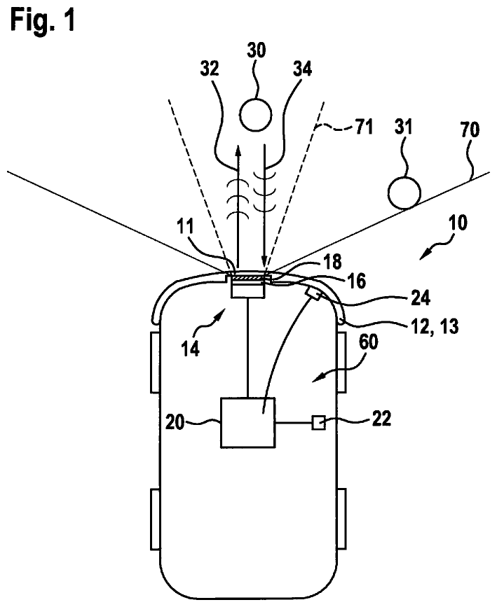

FIG. 1 schematically shows a vehicle 10 including a driver assistance system 60 according to an example embodiment of the present invention. Driver assistance system 60 includes an ultrasonic sensor 14, a temperature sensor 24, and a control unit 20.

Vehicle 10 includes a vehicle part 12, which is illustrated as being designed as a bumper 13. Bumper 13 includes an area 11 having reduced wall thickness. Ultrasonic sensor 14 is situated on the inner side of the outer wall of bumper 13 in area 11 having reduced wall thickness. Due to the arrangement on the inner side of the outer wall of bumper 13, ultrasonic sensor 14 is not visible from the outside, ultrasonic sensor 14 is thus installed on vehicle 10 in a concealed manner.

Ultrasonic sensor 14 is connected to the outer wall of bumper 13 using its diaphragm 16 via an adhesive bond 18 in area 11 having reduced wall thickness. Diaphragm 16 and bumper 13 thus jointly form an oscillating system. The resonant frequency of this oscillating system, which influences an aperture angle 70, 71, is dependent in particular on the material properties of vehicle part 12 and/or bumper 13. Upon increase of the temperature, the resonant frequency decreases, which results in an increase of the aperture angle and, conversely, a reduction of the temperature results in an increase of the resonant frequency, which results in a decrease of the aperture angle.

Two different horizontal aperture angles 70, 71 are outlined in FIG. 1. Larger aperture angle 70 is reached at high temperatures and smaller aperture angle 71 is reached at low temperatures.

To recognize objects 30, 31 in the surroundings of vehicle 10, emitted signals 32 are emitted by driver assistance system 60 using ultrasonic sensor 14 and echoes 34 reflected from objects 30, 31 are in turn received. To suppress interference signals, which occur due to reflections of emitted signal 32 by the ground, a threshold value is provided. Only signals whose amplitudes are greater than the threshold value are interpreted as echo 34 of an object 30, 31.

If the ambient temperature is high, ultrasonic sensor 14 thus has larger opening angle 70, in such a way that emitted signal 32 having a high amplitude is incident not only on centrally located object 30, but rather also on peripherally located further object 31. Accordingly, echoes 34 reflected from objects 30 and 31 also have a high amplitude, in such a way that they are greater than the predetermined threshold value.

At low ambient temperatures, the directional characteristic of ultrasonic sensor 14 changes, in such a way that it now includes small aperture angle 71. Only centrally located object 30 is still located inside small aperture angle 71 defined by the drop of the signal amplitude. Peripherally located further object 31 is located outside small aperture angle 71 and emitted signal 32 is only incident thereon at greatly reduced amplitude, in such a way that an echo 34 of further object 31 is also greatly reduced in its amplitude. Without an adaptation of the threshold value, the amplitude of echo 34 of further object 31 is now less than the threshold value, so that it is no longer recognized. Further object 31 would thus be outside the field of view of ultrasonic sensor 14 without an adaptation of the threshold value.

Because of the reduction of aperture angle 70, 71, however, the amplitude of the ground echoes received as interference signals is also reduced, since a vertical aperture angle (not shown in FIG. 1) is accordingly also decreased and emitted signal 32 is only incident on the ground at a greater distance from vehicle 10 and at a reduced amplitude. It is therefore provided according to the present invention that the threshold value be adapted as a function of the instantaneous directional characteristic of the sensor and be lowered in accordance with the situation described with reference to FIG. 1. By lowering the threshold value, echoes 34 of further object 31 can also still be detected in spite of their reduced amplitude, in such a way that the field of view of ultrasonic sensor 14 at reduced temperatures is enlarged in relation to operation without adaptation of the threshold value.

For the adaptation of the threshold value, it is provided in the example embodiment shown in FIG. 1 that a temperature sensor 24 is situated on bumper 13. In this way, control unit 20 is capable of determining the accurate temperature of vehicle part 12. After the determination of the temperature, for example, a threshold value adapted to the measured temperature can be retrieved from a memory of control unit 20. In alternative example embodiments, temperature sensor 24 can be omitted and a thermometer 22 of vehicle 10 can be used. In this way, the external temperature can be measured and used for an estimation of the temperature of vehicle part 12.

In another example embodiment of the method, instead of measuring a temperature, the resonant frequency of the sound transducer of ultrasonic sensor 14, which is changed because of a change of the material properties of bumper 13, is measured. This can be carried out, for example, via an impedance measurement.

In another alternative example embodiment, signals received by ultrasonic sensor 14 are evaluated for a regulation of the threshold value. The threshold value is increased if a false alarm rate is less than a predetermined value and the threshold value is decreased if the false alarm rate is greater than the predetermined value.

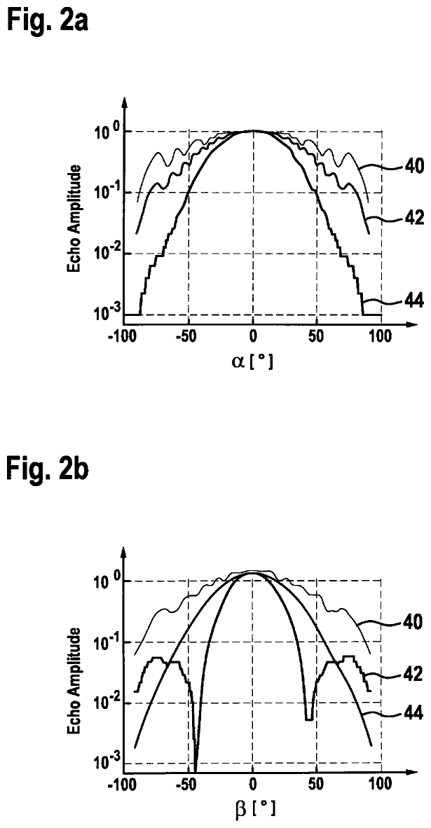

In FIG. 2a, a simulation of the amplitude of an echo signal is plotted as a function of horizontal angle α for three different resonant frequencies. The plotted echo signal is scaled and can originate, for example, from an obstacle or from the ground. First curve 40 shows the curve of the echo amplitude for a resonant frequency of 40 kHz, second curve 42 shows the echo amplitude for a resonant frequency of 48 kHz, and third curve 44 shows the echo amplitude for a resonant frequency of 60 kHz.

In FIG. 2b, vertical aperture angle β is plotted accordingly for the three different resonant frequencies 40 kHz, 48 kHz, and 60 kHz.

As can be inferred from FIGS. 2a and 2b, horizontal aperture angle α or vertical aperture angle β, respectively, decreases upon increase of the resonant frequency. In this way, the emitted signal is only incident on the ground at a greater distance from the ultrasonic sensor, in such a way that the amplitude of the corresponding echo signal also decreases.

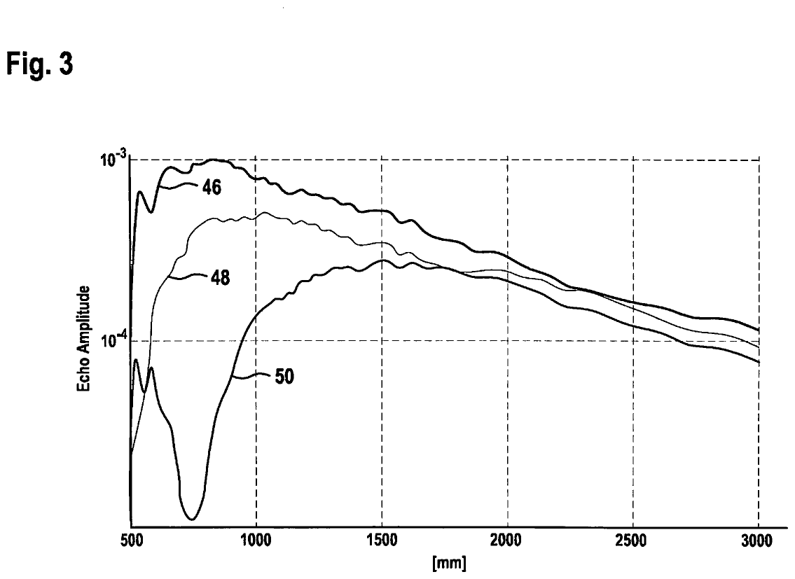

In FIG. 3, the received signal of pulse-echo measurements is plotted for three different resonant frequencies, the ascertained echo amplitude being indicated on the Y axis and the distance computed from the runtime of the signal being indicated in millimeters on the X axis.

In the pulse-echo measurement, a time-limited emitted signal is emitted via ultrasonic sensor 14 and subsequently echoes are received. The more time that has passed since the emission, the greater the distance is of the reflecting object. FIG. 3 shows the received signal for resonant frequency of 42 kHz in a first curve 46, a second measurement curve 48 shows the received signal for a resonant frequency of 48 kHz, and a third measurement curve 50 shows the received signal for a resonant frequency of 57 kHz.

It can be inferred from the illustration of FIG. 3 that, as expected for third measurement curve 50, which corresponds to the highest frequency used, the aperture angle is smallest and thus supplies the smallest echo amplitudes for the ground echoes at short distances. At longer distances from approximately 175 cm, third measurement curve 50 has an increased amplitude compared to second measurement curve 48 and from approximately 225 cm, third measurement curve 50 has the greatest echo amplitude. This can be explained via the improved directional effect due to the smallest aperture angle.

It is apparent from FIG. 3 that, utilizing the knowledge of the resonant frequency dependent on the environmental conditions and thus utilizing the directional characteristic dependent on the environmental conditions, a threshold value for suppressing ground echoes can be greatly reduced. It is advantageous in particular in this case to combine the threshold value dependent on the directional characteristic with a dependence on the distance, to always be able to specify an optimum threshold value for any distance and for any directional characteristic.

The present invention is not restricted to the example embodiments described here and the aspects highlighted therein. Rather, a variety of modifications are possible within the scope specified by the claims, which are routine measures for those skilled in the art.

1-10. (canceled)

11. A method for adapting a threshold value, which is used to suppress interference signals in pulse-echo measurements by an ultrasonic sensor that is installed in a concealed manner in a vehicle with a diaphragm of the ultrasonic sensor being connected to a vehicle part, to a directional characteristic of the ultrasonic sensor that is influenced by instantaneous properties of the vehicle part, the method comprising:
ascertaining a temperature and determining the threshold value based on the ascertained temperature and a previously determined temperature to directional characteristic relationship; or
determining a resonant frequency of an oscillating system formed by the diaphragm and the vehicle part and determining the threshold value based on the determined resonant frequency and a previously determined resonant frequency to directional characteristic relationship.

12. The method of claim 1, wherein the threshold value is determined based on the ascertained temperature, and the temperature is:
an external temperature ascertained via a thermometer of the vehicle; or
a temperature of the vehicle part ascertained via a temperature sensor situated on the vehicle part or on the ultrasonic sensor.

13. The method of claim 1, wherein the relationship on the basis of which the threshold value is determined is ascertained by prior measurements.

14. The method of claim 1, wherein the threshold value is determined based on determined resonant frequency, and the resonant frequency of the oscillating system is determined via a measurement of an impedance of the ultrasonic sensor.

15. The method of claim 1, wherein the threshold value is determined based on the ascertained temperature, and the determination of the threshold value is based on a value table that associates a plurality of temperature values with respective values for the threshold value.

16. The method of claim 1, wherein the threshold value is determined based on the determined resonant frequency, and the determination of the threshold value is based on a value table that associates a plurality of resonant frequency values with respective values for the threshold value.

17. The method of claim 1, wherein the interference signals include signals of ground reflections, a number of which increases by a widening of the directional characteristic and decreases by a narrowing of the directional characteristic.

18. A method comprising:
based on interference signals in pulse-echo measurements, which are performed by an ultrasonic sensor that is installed in a concealed manner in a vehicle with a diaphragm of the ultrasonic sensor being connected to a vehicle part whose instantaneous properties influence a directional characteristic of the ultrasonic sensor, regulating a threshold value used for suppressing the interference signals.

19. The method of claim 7, wherein the threshold value is regulated such that a constant predetermined false alarm rate is maintained.

20. A non-transitory computer-readable medium on which are stored instructions that executable by a processor and that, when executed by the processor, cause the processor to perform a method for regulating a threshold value, which is used to suppress interference signals in pulse-echo measurements by an ultrasonic sensor that is installed in a concealed manner in a vehicle with a diaphragm of the ultrasonic sensor being connected to a vehicle part, the method comprising:
adapting the threshold value to a directional characteristic of the ultrasonic sensor that is influenced by instantaneous properties of the vehicle part, the adapting being performed by:
ascertaining a temperature and determining the threshold value based on the ascertained temperature and a previously determined temperature to directional characteristic relationship; or
determining a resonant frequency of an oscillating system formed by the diaphragm and the vehicle part and determining the threshold value based on the determined resonant frequency and a previously determined resonant frequency to directional characteristic relationship; or
regulating the threshold value based on a measurement of the interference signals.

21. A driver assistance system for assisting a driver of a vehicle, the driver assistance system comprising:
an ultrasonic sensor installed in a concealed manner in a vehicle part of the vehicle and including a diaphragm that, together with the vehicle part, forms an oscillating system;
a control unit, wherein the control unit is configured to perform a method for regulating a threshold value, which is used to suppress interference signals in pulse-echo measurements by the ultrasonic sensor, the method comprising:
adapting the threshold value to a directional characteristic of the ultrasonic sensor that is influenced by instantaneous properties of the vehicle part, the adapting being performed by:
ascertaining a temperature and determining the threshold value based on the ascertained temperature and a previously determined temperature to directional characteristic relationship; or
determining a resonant frequency of an oscillating system formed by the diaphragm and the vehicle part and determining the threshold value based on the determined resonant frequency and a previously determined resonant frequency to directional characteristic relationship; or
regulating the threshold value based on a measurement of the interference signals.
